(19) United States
(12) Patent Application Publication
(10) Pub. No.: US 2016/0169664 A1
(43) Pub. Date: Jun. 16, 2016

(54) STRESS DISPLAY MEMBER AND STRAIN MEASUREMENT METHOD USING STRESS DISPLAY MEMBER

(71) Applicant: FUJIFILM Corporation, Tokyo (JP)

(72) Inventors: Takahiro HAYASHI, Fujinomiya-shi (JP); Yoshihito HODOSAWA, Fujinomiya-shi (JP)

(73) Assignee: FUJIFILM Corporation, Tokyo (JP)

(21) Appl. No.: 15/047,861

(22) Filed: Feb. 19, 2016

Related U.S. Application Data
(63) Continuation of application No. PCT/JP2014/072743, filed on Aug. 29, 2014.

(30) Foreign Application Priority Data
Aug. 30, 2013 (JP) 2013-179403

(51) Int. Cl. G01B 11/16; G02F 1/13; G02B 5/30; G01L 1/24; G02F 1/01

(52) U.S. Cl. CPC G01B 11/16; G01L 1/241; G02F 1/0131; G02B 5/30; G02F 1/13

(57) ABSTRACT

The invention provides a stress display member including: a selective reflection layer, in which the selective reflection layer includes cholesteric liquid crystal layers that are obtained by curing a liquid crystal composition including a polymerizable liquid crystal compound, and the selective reflection layer is a layer that selectively reflects circularly polarized light having any one sense of right-handed circularly polarized light and left-handed circularly polarized light in a specific wavelength, a stress display member further including a birefringence layer and optionally including a circularly polarized light separating layer, and a strain measurement method that is performed by using any one of the stress display member. According to the stress display member of the invention, it is possible to measure and visually observe a strain that occurs in a target having a large surface area at a low cost and measure a strain with high measuring accuracy.

### CROSS-REFERENCE TO RELATED APPLICATIONS

This application is a continuation of PCT International Application No. PCT/JP2014/072743 filed on Aug. 29, 2014, which claims priority under 35 U.S.C §119 (a) to Japanese Patent Application No. 2013-179403 filed on Aug. 30, 2013, the entire content of which is incorporated herein by reference.

### BACKGROUND OF THE INVENTION

1. Field of the Invention

The present invention relates to a stress display member and a strain measurement method using the stress display member. More specifically, the invention relates to a stress display member including a cholesteric liquid crystal layer formed of a composition including a polymerizable cholesteric liquid crystal compound, and a strain measurement method using a stress display member.

2. Description of the Related Art

In the related art, as a method of measuring a strain of an object, a method of using a strain gauge, a photoelastic modeling method, a photoelastic film coating method, a stress painting method, a moire method, a holography method, a speckle method, a thermoelastic method, a copper plating stress measuring method, and a method using a piezoelectric material are known.

JP1980-31402B2 (JP-S55-31402 B2) discloses a method of measuring stress (strain) using selective wavelength reflection properties of a cholesteric liquid crystal. According to this method, it is possible to measure stress from the change of coloration of reflected light.

JP2006-28202A discloses a strain measurement method using a strain sensor film formed with particles (monodispersed polystyrene) which are periodically and evenly arranged by self-organization and an elastic body (polydimethylsilicone) with which portions between particles are filled. In this method, the strain distribution is visually observed, and thus, an optical microscope, a scanning electron microscope, a laser device, and the like do not need a special display apparatus, and thus, are convenient.

### SUMMARY OF THE INVENTION

Among measuring methods of the strain of an object which are well-known in the related art, a method of using a strain gauge is highly quantitative and widely spread. However, since the method of using a strain gauge is point measurement, if a large surface area is measured for evaluating strain distribution, the number of measuring points is large, and thus, a labor of wiring and a large number of measuring devices is required. Therefore, the costs thereof are high. In addition, measurement is performed by processing an electric signal, and thus, a strain cannot be visually observed to be checked in a field. In a photoelastic model method, the strain distribution generated in a plastic model can be visually observed with polarized light, but, since the photoelastic model method is a model test, the highly accurate measurement may not be performed, and a polarized light measuring device is expensive. In the photoelastic film coating method, a strain can be directly measured by pasting a photoelastic resin to an object to be measured, but a polarized light measuring device is expensive in the same manner as in a photoelastic method, and the strain distribution cannot be visually observed by eyes. In the stress film coating method, a strain having a complicated shape can be measured by applying brittle paint and thus, the strain distribution can be evaluated, but since the strain distribution is determined by the density of cracks generated in the coated film, and thus, quantitativity is low and a drying condition of the paint influences the measuring accuracy, highly accurate measurement is difficult.

In JP1980-31402A (JP-S55-31402A), since a cholesteric liquid crystal is in a liquid crystal state and thus, has fluidity, if an external environment such as a temperature, an electric field, and pressure changes in a state in which a certain amount of the reflection wavelength is changed due to the deformation by the strain, the reflection wavelength changes due to the external environment, and thus, highly accurate measurement is difficult.

In the method disclosed in JP2006-28202A, Bragg diffraction due to the lattice distance of monodispersed particles self-organized in a tightly-packed structure is used, and thus, lattice distance cannot be reduced. In addition, the lattice distance can be changed by soaking the elastic body by using capillarity phenomenon so as to expand the lattice distance, but it is difficult to control the lattice distance evenly and highly accurately in a wide surface area. Further, in order to perform self-organization arrangement on the monodispersed particles, a drying step for several hours is required and the elastic body is repeatedly soaked several times until a sufficient lattice distance is obtained. Therefore, a labor and time are required. Accordingly, the strain sensor film is not continuously produced, and the mass production thereof is difficult.

An object of the invention is to provide a novel stress display member and a novel strain measurement method using the stress display member. Specifically, the invention is to provide a stress display member that can measure a strain that occurs in a target having a large surface area at a low cost, and that can measure a strain with high measuring accuracy.

In order to solve the problem above, the inventors of the invention diligently performed examinations, found that a strain generated in a target having a large surface area can be very accurately measured by using a member including a cholesteric liquid crystal layer formed by using a polymerizable liquid crystal compound, and completed the invention based on this knowledge.

That is, the invention is to provide [1] to [22] below.

[1] A stress display member including: a selective reflection layer, in which the selective reflection layer includes one or more cholesteric liquid crystal layers that are obtained by curing a liquid crystal composition including a polymerizable liquid crystal compound, and the selective reflection layer is a layer that selectively reflects circularly polarized light having any one sense of right-handed circularly polarized light and left-handed circularly polarized light in a selective reflection wavelength.
[2] The stress display member according to [1], in which the polymerizable liquid crystal compound includes a polyfunctional liquid crystal compound having 2 or more polymerizable groups and a monofunctional liquid crystal compound having one polymerizable group, and in which a mass ratio of the polyfunctional liquid crystal compound and the monofunctional liquid crystal compound is 30/70 to 99/1.
[3] The stress display member according to [1] or [2], further including: a birefringence layer, in which the birefringence layer is a layer in which birefringence changes if stress is applied.
[4] The stress display member according to [3], in which an absolute value of a photoelastic coefficient of the birefringence layer is indicated by a unit of Pa⁻¹ is 20×10⁻¹² to 1×10⁻⁶.
[5] The stress display member according to [3] or [4], further including: a circularly polarized light separating layer in which the circularly polarized light separating layer is a layer that selectively transmits circularly polarized light in a wavelength region including the selective reflection wavelength.
[6] The stress display member according to [5], in which a sense of the circularly polarized light transmitted by the circularly polarized light separating layer is the same as a sense of the circularly polarized light selectively reflected by the selective reflection layer.
[7] The stress display member according to [5], in which the sense of the circularly polarized light transmitted by the circularly polarized light separating layer is the reverse of the sense of the circularly polarized light selectively reflected by the selective reflection layer.
[8] The stress display member according to any one of [5] to [7], further including: the selective reflection layer, the birefringence layer, and the circularly polarized light separating layer, in this sequence.
[9] The stress display member according to any one of [5] to [8], in which the circularly polarized light separating layer is a layer made with a laminated body including a linearly polarized light separating layer and a λ/4 phase difference layer.
[10] The stress display member according to [9], in which an absolute value of the photoelastic coefficient of the λ/4 phase difference layer is indicated by a unit of Pa⁻¹ is 20×10⁻¹² to 1×10⁻⁶.
[11] The stress display member according to any one of [5] to [8], in which the circularly polarized light separating layer includes a cholesteric liquid crystal layer obtained by curing a liquid crystal composition including a polymerizable liquid crystal compound.
[12] The stress display member according to [11], in which a spiral pitch of one or more cholesteric liquid crystal layers included in the selective reflection layer is identical to a spiral pitch of one or more cholesteric liquid crystal layers included in the circularly polarized light separating layer.
[13] The stress display member according to any one of [3] to [12], in which the selective reflection layer includes 2 or more cholesteric liquid crystal layers obtained by curing a liquid crystal composition including a polymerizable liquid crystal compound, and spiral pitches of the 2 or more cholesteric liquid crystal layers are different from each other.
[14] The stress display member according to [13], in which a difference between peak wavelengths of the 2 or more cholesteric liquid crystal layers that selectively reflect circularly polarized light is 50 nm or greater.
[15] The stress display member according to any one of [1] to [14], which is a film having a film thickness of 1,000 μm or less.
[16] The stress display member according to any one of [1] to [15] further including an adhesive layer in the outermost layer.
[17] The stress display member according to any one of [1] to [16], further including a light shielding layer.
[18] A strain measurement method of a target, including: adhering the stress display member according to any one of [1] to [17] to the target; and measuring reflected light or transmitted light obtained by irradiating the stress display member with light in a wavelength region including a selective reflection wavelength.
[19] A strain measurement method of a target, including: disposing the stress display member according to any one of [1] to [16], a light shielding film, and the target in this sequence; adhering the stress display member, the light shielding film, and the target; and measuring reflected light obtained by irradiating the stress display member with light.
[20] A strain measurement method of a target including: adhering the stress display member according to any one of [3] to [14] to the target; and measuring reflected light obtained by irradiating the stress display member with circularly polarized light in a wavelength region including the selective reflection wavelength.
[21] A strain measurement method of a target, including: adhering the stress display member according to any one of [1] to [17]; and measuring reflected light or transmitted light obtained by irradiating the stress display member with light, in which the peak wavelength of the irradiated light is in a wavelength region in which the selective reflection layer selectively reflects light, and the wavelength region of the irradiated light is smaller than a wavelength region in which the selective reflection layer selectively reflects light.
[22] The strain measurement method according to any one of [18] to [21], in which the measurement is performed through a viewing angle restricting film.

According to the invention, there are provided a novel stress display member and a novel strain measurement method using the stress display member. It is possible to cost-efficiently and highly accurately measure a strain generated in a target having a large surface area by using a stress display member.

### BRIEF DESCRIPTION OF THE DRAWING

FIG. 1 is a diagram (a schematic sectional view) illustrating a configuration example of a stress display member according to the invention.

### DESCRIPTION OF THE PREFERRED EMBODIMENTS

Hereinafter, the invention is described in detail.

In addition, in this specification, the expression “to” is used as a meaning including numerical values before and after the expression as a lower limit and an upper limit.

In this specification, the expression “selectively” with respect to circularly polarized light means that a quantity of light of any one of a right-handed circularly polarized light component or a left-handed circularly polarized light component of the irradiated light is greater than that of the other one. Specifically, when the expression “selectively” is used, the circularly polarized light intensity of the light is preferably 0.3 or greater, more preferably 0.6 or greater, and particularly preferably 0.8 or greater. Practically, the circularly polarized light intensity is further preferably 1.0. Here, the circularly polarized light intensity is a value expressed by |I_{R}−I_{L}|/(I_{R}+I_{L}) where an intensity of the right-handed circularly polarized light component of the light is represented by I_{R}, and an intensity of the left-handed circularly polarized light component is represented by I_{L}.

In this specification, the expression “sense” with respect to circularly polarized light means whether the circularly polarized light is right-handed circularly polarized light or left-handed circularly polarized light. The sense of the circularly polarized light is defined as right-handed circularly polarized light in a case where a tip of an electric field vector turns clockwise according to the increase of the time when the light is seen such that the light progresses forward and is defined as left-handed circularly polarized light in a case where a tip of an electric field vector turns counterclockwise.

According to the specification, the expression “sense” may be used for the twisting direction of a screw of a cholesteric liquid crystal. With respect to selective reflection by a cholesteric liquid crystal, right-handed circularly polarized light is reflected and left-handed circularly polarized light is transmitted in a case where a twisting direction (sense) of a screw of the cholesteric liquid crystal is rightward. Otherwise, left-handed circularly polarized light is reflected and right-handed circularly polarized light is transmitted in a case where a sense is leftward.

In addition, the state of the polarized light at the respective wavelengths of the light can be measured by using a spectral radiance meter or a spectrometer to which a circularly polarizing plate is mounted. In this case, an intensity of light measured by the right-handed circularly polarizing plate corresponds to I_{R}, and an intensity of light measured by the left-handed circularly polarizing plate corresponds to I_{L}. In addition, a normal light source such as a light bulb, a mercury lamp, a fluorescent light, and LED generates almost natural light, but the characteristics of producing polarized light of a member for controlling the state of the polarized light by mounting a circularly polarizing plate to such a light source can be measured, for example, by using a polarized light phase difference analyzer AxoScan, manufactured by Axometrics Inc.

In addition, the measuring can be performed by installing a circularly polarizing plate to an illuminometer or a photospectrometer. The ratio can be measured by attaching a right-handed circularly polarized light transmitting plate so as to measure a quantity of right-handed circularly polarized light and attaching a left-handed circularly polarized light transmitting plate so as to measure a quantity of left-handed circularly polarized light.

In this specification, the light intensity required for the calculation of a light reflectance or a light transmittance may be measured, for example, by using a normal visible and near infrared spectrometer.

In this specification, the expression “phase difference” indicates in-plane retardation (Re). If there is no particular indication with respect to a wavelength, the expression indicates a phase difference at a wavelength of 550 nm.

In this specification, the photoelasticity refers to properties of generating anisotropy in an object in which stress is generated thereby generating birefringence. A phase difference generated due to birefringence, and a phase difference generated per unit stress and per unit optical path is called a photoelastic coefficient.

In this specification, the expression “strain amount” refers to a deformation amount per unit length in a case where stress is generated in an object. Specifically, when an object with a length L stretches by ΔL by tensile stress or shrinks by ΔL, a value expressed by ΔL/L is called strain amount.

(Stress Display Member)

The stress display member according to the invention is a member that can indicate stress (strain) generated from itself in a form that can be detected from the outside. The detection may be visually performed or may be performed by using a measuring device and the like. The embodiment in which the stress display member can detect a strain is preferably an embodiment in which a strain can be optically detected in view of measuring distribution of a strain, and examples thereof include a change of a wavelength of reflected light or transmitted light and a change of an intensity of reflected light or transmitted light. The stress display member may be indicated by a form in which a strain generated in a target can be detected from the outside by being adhered to the target for strain measurement. In this manner, the stress display member can be used, for example, as a strain measuring film. A material of the target for strain measurement is not particularly limited, examples thereof include metal, concrete, ceramic, glass, rubber, plastic, paper, and fiber, and the target may be a transparent body or may be an opaque body. A surface to which a stress display member is pasted may be a flat surface or may have unevenness. In addition, for example, it is considered that the stress display member is used as an optical shutter in which transmittance of light in a desired wavelength region changes, if the stress display member is expanded. The stress display member according to the invention preferably has a film shape or a sheet shape.

When the stress display member is used as a strain measuring film that is attached to a target to be used, if the film thickness is too great, the stress display member functions as resistance of deformation of an target due to the rigidity of the stress display member, and thus, a strain amount in the related art may not be measured. In addition, stress between a target and a cholesteric liquid crystal layer, described below, or a birefringence layer is alleviated, and thus, strain measuring accuracy is deteriorated. Therefore, in order to track a strain of a target, it is preferable that the film thickness of the stress display member is 1,000 μm or less, preferably 500 μm or less, more preferably 300 μm or less, and particularly preferably 100 μm or less. When the stress display member is manufactured by Roll to Roll processing, if the film thickness is 1,000 μm or less, the stress display member can be easily wound in a roll shape and mass production becomes convenient. Meanwhile, if the thickness is small, the film does not have strength, work of adhering the stress display member having a large surface area to a target becomes extremely difficult. Therefore, it is preferable that, in a state before the stress display member is adhered to the object to be measured, the film thickness is 1 or greater, preferably 5 μm or greater, more preferably 10 μm or greater, and particularly preferably 15 μm or greater.

The stress display member according to the invention includes a selective reflection layer including at least one cholesteric liquid crystal layer.

(Stress Display Member in First Embodiment)

On the selective reflection layer included in the stress display member according to the invention, light in a specific wavelength corresponding to a pitch length in a screw structure in the cholesteric liquid crystal layer described below is reflected (selective reflection wavelength). The selective reflection wavelength is not particularly limited, and may be in an infrared light region, in a visible light region, or in a ultraviolet light region. If the selective reflection wavelength is in a visible light region of 350 nm to 850 nm and preferably 380 nm to 780 nm, selective reflected light can be recognized. When the selective reflection layer includes 2 or more cholesteric liquid crystal layers having different pitch lengths in the screw structure, 2 or more selective reflection wavelengths may be included.

If stress is generated in the stress display member thereby generating a strain, the thickness of the stress display member changes, the spiral pitch of the cholesteric liquid crystal accordingly changes, and thus, the selective reflection wavelength also changes. The change of the wavelength can be detected as a strain. If the selective reflection wavelength is in the visible light region, the change of the wavelength can be detected as the change of the color, and thus, the strain is visually observed. The stress display member according to the invention can measure a strain amount of the object by being attached to the object (target).

Since the cholesteric liquid crystal has fluidity in a liquid crystal state, a reflection wavelength changes even by the influence on the external environment change such as a temperature, an electric field, and pressure. Therefore, highly accurate measurement becomes difficult. As described below, the cholesteric liquid crystal layer included in the stress display member according to the invention is a layer obtained by curing the liquid crystal composition including the polymerizable liquid crystal compound, and the structure is stabilized by the polymerization of the polymerizable liquid crystal compound. Therefore, the cholesteric liquid crystal layer is hardly influenced by change in external environment such as a temperature, an electric field, and pressure, and thus, highly accurate strain measurement becomes possible.

As the strain amount of the target increases, the change of the reflection wavelength becomes great, and thus, the strain can be easily recognized. Therefore, in order to use the stress display member according to the invention for strain detection by recognition, it is preferable that 5% or greater of the strain amount becomes a target. The upper limit of the strain amount that becomes the target is not particularly limited, but the upper limit is about 25%.

In addition to the recognition, the strain can be detected in a method of measuring the change of the reflection wavelength with a spectrophotometer. The strain can be easily detected when the strain amount is less than 5% by using the spectrophotometer. The lower limit of the strain amount that can detect by using the spectrophotometer is generally about 1%.

Examples of the strain detection method include a method of performing an image treatment by imaging the stress display member with a digital camera and obtaining the image in a personal computer, in addition to the above.

(Stress Display Member of Second Embodiment)

If the stress display member according to the invention has a birefringence layer in addition to the selective reflection layer, the strain measurement having higher sensitivity becomes possible. At this point, the birefringence layer is disposed in the stress display member to be positioned between a light source and the selective reflection layer and is irradiated with the circularly polarized light, so as to measure reflected light or transmitted light, generally, reflected light. If stress is generated in the birefringence layer and the birefringence layer is deformed, birefringence is generated according to the strain amount, but the state of the polarized light of the circularly polarized light that is transmitted by the birefringence layer in the phase difference due to the birefringence changes, the reflectance of the reflected light that is selectively reflected on the selective reflection layer changes. The stress generated in the stress display member can be evaluated by detecting the change of the reflectance, and thus, if the stress display member is attached to the object to be used, the stress display member can be used as a strain sensor. In the stress display member of the second embodiment, a smaller strain than that detected in the stress display member of the first embodiment can be visually detected and particularly appropriate for the measurement of less than 5% of the strain. At this point, the lower limit of the detectable strain amount is generally about 0.001%.

The circularly polarized light for measuring the strain may be applied by using the light source of the circularly polarized light, a circularly polarized light separating film may be disposed between the light source and the stress display member, and the stress display member may have the circularly polarized light separating layer.

As the circularly polarized light separating film or the circularly polarized light separating layer, any existing type of the circularly polarized light separating film or the circularly polarized light separating layer can be used, but a circularly polarized light filter obtained by laminating the linearly polarized light layer and the λ/4 phase difference layer or the cholesteric liquid crystal layer that can be obtained by curing the liquid crystal composition including the polymerizable liquid crystal compound may be used.

Each of the selective reflection layer or the circularly polarized light separating layer may be formed of 2 or more cholesteric liquid crystal layers, or may include 2 or more cholesteric liquid crystal layers such that an alignment layer, an adhesive layer, or the like is included in each of the cholesteric liquid crystal layers.

If the circularly polarized light filter obtained by laminating the linearly polarized light layer and the λ/4 phase difference layer is used as the circularly polarized light separating film or the circularly polarized light separating layer, the λ/4 phase difference layer may function as the birefringence layer.

In the stress display member including the birefringence layer, a selective reflection layer including 2 or more cholesteric liquid crystal layers having different pitch lengths in the screw structure and different selective reflection wavelengths is preferably used. Accordingly, 2 or more cholesteric liquid crystal layers in the same manner as the circularly polarized light separating layer may be included. Since the phase difference generated in the birefringence layer has a wavelength dependency, brightness of the light in the reflection wavelength becomes different due to the 2 or more cholesteric liquid crystal layers, and thus, coloration of the stress display member changes. Accordingly, the stress can be detected as the color change. At this point, if the wavelength differences of the selective reflection wavelengths of the respective layers are caused to become great, the difference between the phase differences due to the wavelength dependency can be caused to be great, and thus, a smaller strain can be detected. It is preferable that the wavelength difference of each layer is 50 nm or greater, preferably 100 nm or greater, more preferably 150 nm or greater, and particularly preferably 200 nm or greater. It is possible to cause the change of the color to be easily detected (recognized), by adjusting selective reflection wavelengths of the 2 or more cholesteric liquid crystal layers to have a relationship of 2 complementary colors (yellow/blue violet, orange/blue, red/green, or the like). The wavelength difference for causing the colors to become complementary colors is not uniform, but is preferably adjusted to 50 nm or greater. For example, the wavelength difference can be adjusted in the range of 400 nm to 560 nm, in the range of 430 nm to 580 nm, in the range of 490 nm to 620 nm, and in the range of 560 nm to 800 nm. In addition, the adjustment of the wavelength difference is performed at the peak wavelength of a light reflection spectrum. The peak wavelength refers to a wavelength of which reflectance is highest.

(Configuration of Stress Display Member)

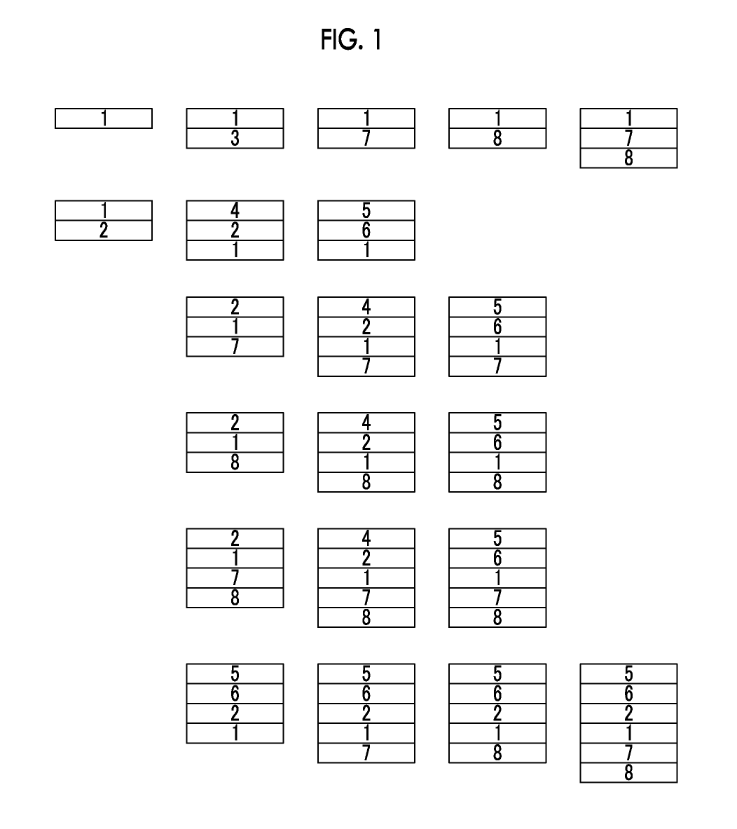

In addition to the selective reflection layer, the stress display member according to the invention includes a birefringence layer, a circularly polarized light separating layer, a support, an adhesive layer, or a light shielding layer, if necessary. An example of a layer configuration that may be taken by the stress display member according to the invention is illustrated in FIG. 1.

Hereinafter, the composition and the manufacturing method of respective layers configuring the stress display member according to the invention, and the member used in the strain measurement using the stress display member according to the invention are described.

(Cholesteric Liquid Crystal Layer)

The cholesteric liquid crystal layer may be included in the selective reflection layer or may be included in the circularly polarized light separating layer.

The cholesteric liquid crystal layer can be obtained by curing the liquid crystal composition including the polymerizable liquid crystal compound. With respect to the cholesteric liquid crystal layer, the cholesteric liquid crystal phase is fixed due to the polymerization reaction or the like by a polymerizable group of the polymerizable liquid crystal compound.

It is known that the cholesteric liquid crystal phase exhibits circularly polarized light selective reflection in which any one of the right-handed circularly polarized light or the left-handed circularly polarized light is selectively reflected and the other the circularly polarized light is transmitted. The cholesteric liquid crystal compound exhibiting the circularly polarized light selective reflection properties or the film formed of the cholesteric liquid crystal compound have well known in the related art, and the related art can be referred to for the selection and the manufacturing of the cholesteric liquid crystal layer.

In the cholesteric liquid crystal layer, the alignment of the liquid crystal compound that becomes the cholesteric liquid crystal phase is maintained. Typically, the cholesteric liquid crystal layer may be a layer in which the polymerizable liquid crystal compound is caused to have the alignment state of the cholesteric liquid crystal phase, is polymerized and cured by the ultraviolet ray irradiation, heating, and the like so as to form a layer not having fluidity, and is also changed to a state in which the alignment state is not changed by an external field or an external force. In addition, in the cholesteric liquid crystal layer, it is sufficient that optical properties of the cholesteric liquid crystal phase are maintained in the layer, and the liquid crystalline compound in the layer does not need to exhibit liquid crystallinity. For example, the polymerizable liquid crystal compound is caused to have a high molecular weight due to a curing reaction, so as not to have liquid crystallinity.

In this specification, the cholesteric liquid crystal layer may be called a liquid crystal layer.

The cholesteric liquid crystal layer shows circularly polarized light selective reflection derived from the screw structure of a cholesteric liquid crystal. A central wavelength λ of the reflection depends on a pitch length P (=cycle of screw) of the screw structure in the cholesteric liquid crystal phase, and has the relationship of λ=n×P with an average refractive index n of the cholesteric liquid crystal phase. Therefore, the wavelength indicating the circularly polarized light reflection can be adjusted by regulating the pitch length of the screw structure. That is, for example, when the cholesteric liquid crystal layer having the selective reflection wavelength in the visible light wavelength region is formed, an n value and a P value are regulated such that any one of the right-handed circularly polarized light or the left-handed circularly polarized light is selectively reflected in at least a portion of the wavelength region of 350 nm to 850 nm. Since the pitch length of the cholesteric liquid crystal phase depends on the type and the addition concentration of the chiral agent to be used together with the polymerizable liquid crystal compound, a desired pitch length can be obtained by adjusting the type and the addition concentration of the chiral agent. In addition, as a method of measuring a sense of a screw or a pitch, methods disclosed in “Introduction to liquid crystal chemical test” edited by Japanese Liquid Crystal Society, published by Sigma Publishing in 2007, page 46, and “Handbook of liquid crystals”, Liquid Crystal Editing Committee, Maruzen, page 196 can be used.

In the half-value width of the circularly polarized light selective reflection band, Δλ, depends on birefringence Δn of the liquid crystal compound and the pitch length P, so as to have the relationship of Δλ=Δn×P. Therefore, the control of the selective reflection band can be performed by adjusting Δn. The adjustment of Δn can be performed by adjusting the type of the polymerizable liquid crystal compound or the mixture ratio thereof, or by controlling the temperature at the time of alignment fixation.

The sense of the reflected circularly polarized light of the cholesteric liquid crystal layer is identical to that of the screw.

As the stress display member according to the invention, any type of the cholesteric liquid crystal layer of which the sense of the screw is left-handed or right-handed can be used. The reflectance of the reflection wavelength increases as the cholesteric liquid crystal layer is thicker, but, with the normal liquid crystal material, the reflectance is saturated in the thickness of 2 μm to 8 μm in the wavelength region of the visible light. When laminating is performed in order to increase circularly polarized light selectivity in a specific wavelength, plural cholesteric liquid crystal layers having the same cycle P and the same sense of the screw may be laminated. At this point, plural cholesteric liquid crystal layers separately manufactured may be stuck with an adhesive agent, or the cholesteric liquid crystal layer described below may be formed by applying the liquid crystal composition including the polymerizable liquid crystal compound, or the like, directly on the surface of the cholesteric liquid crystal layer formed in advance and performing the aligning and fixing steps.

In a normal material in the visible light region, the width of the circularly polarized light reflection wavelength region is 50 nm to 100 nm, and thus, the bandwidth of the reflection can be expanded by laminating plural types of cholesteric liquid crystal layers having different central wavelengths of the reflected light in which the cycle P is changed. At this point, it is preferable that cholesteric liquid crystal layers having the same sense of the screw are laminated. In addition, in one cholesteric liquid crystal layer, the bandwidth of the reflection can be widened by smoothly changing the cycle P in the film thickness direction.

(Method of Manufacturing Cholesteric Liquid Crystal Layer)

Examples of the material used for the forming of the cholesteric liquid crystal layer include a liquid crystal composition including a polymerizable liquid crystal compound and a chiral agent (optically active compound). The liquid crystal composition which is further mixed with a surfactant, a polymerization initiator, and the like, if necessary and is dissolved in a solvent or the like is applied on a substrate (a support, an alignment layer, a cholesteric liquid crystal layer which becomes a lower layer, and the like), fixation is performed after cholesteric alignment maturing, and then a cholesteric liquid crystal layer can be formed.

Polymerizable Liquid Crystal Compound

The polymerizable liquid crystal compound may be a cylindrical liquid crystal compound or may be a disk-shaped liquid crystal compound, but is preferably a cylindrical liquid crystal compound.

Examples of the cylindrical polymerizable liquid crystal compound forming the cholesteric liquid crystal layer include a cylindrical nematic liquid crystal compound. As the rod-like nematic liquid crystal compound, azomethines, azoxys, cyanobiphenyls, cyanophenyl esters, benzoic acid ester, phenyl cyclohexane carboxylic acid ester, cyanophenyl cyclohexanes, cyano-substituted phenyl pyrimidines, alkoxy-substituted phenyl pyrimidines, phenyl dioxanes, tolanes, and alkenyl cyclohexyl benzonitriles are preferably used. Not only a low molecular liquid crystal compound, but also a high molecular liquid crystal compound can be used.

The polymerizable liquid crystal compound can be obtained by introducing the polymerizable group to the liquid crystal compound. Examples of the polymerizable group include an unsaturated polymerizable group, an epoxy group, and an aziridinyl group, an unsaturated polymerizable group is preferable, and an ethylenically unsaturated polymerizable group is particularly preferable. The polymerizable group can be introduced to the molecule of the cholesteric liquid crystal compound in various methods. The number of polymerizable groups included in the polymerizable liquid crystal compound is preferably 1 to 6 and more preferably 1 to 3. Examples of the polymerizable cholesteric liquid crystal compound include compounds disclosed in Makromol. Chem., Volume 190, page 2255 (1989), Advanced Materials Volume 5, page 107 (1993), U.S. Pat. No. 4,683,327A, U.S. Pat. No. 5,622,648A, U.S. Pat. No. 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-328973A, and the contents disclosed in these publications are incorporated in this specification. 2 or more types of the polymerizable liquid crystal compounds may be used together. If 2 or more types of the polymerizable liquid crystal compounds are used together, the alignment temperature can be reduced.

In the stress display member according to the invention, the cholesteric liquid crystal layer may track the stress, and thus, the cholesteric liquid crystal layer is required not to be broken. Particularly, in order to use the stress display member according to the first embodiment for the use of measuring a large strain amount, the stress display member is required to track a large strain. In the cholesteric liquid crystal layer, flexibility can be controlled by controlling 3 dimensional crosslinking density. Specifically, as the ratio of the polyfunctional liquid crystal compound having 2 or more polymerizable groups is larger, the crosslinking density becomes greater, and thus, the flexibility of the film can be adjusted by the ratio of a multifunctional liquid crystal compound having 2 or more polymerizable groups and a monofunctional cholesteric liquid crystal having one polymerizable group. In addition, if the ratio of the multifunctional liquid crystal compound is high, a plane-shaped failure is easily generated by the precipitation of crystals. However, a satisfactory plane-shaped cholesteric liquid crystal layer can be obtained by mixing the monofunctional liquid crystal compound so as to control the crystallization. Meanwhile, if the ratio of the monofunctional liquid crystal compound becomes great, selective wavelength reflection due to the cholesteric liquid crystal may not be obtained. It is considered that this is because the screw structure may not be maintained. Specifically, the mass ratio of the polyfunctional liquid crystal compound and the monofunctional liquid crystal compound (polyfunctional liquid crystal compound/monofunctional liquid crystal compound) may be adjusted between 30/70 to 99/1. Generally, the polyfunctional liquid crystal compound/monofunctional liquid crystal compound is preferably adjusted to 70/30 to 90/10.

In addition, the addition amount of the polymerizable liquid crystal compound in the liquid crystal composition is preferably 80 mass % to 99.9 mass %, more preferably 85 mass % to 99.5 mass %, and particularly preferably 90 mass % to 99 mass % with respect to the solid content mass (mass except for the solvent) of the liquid crystal composition.

Chiral Agent (Optically Active Compound)

The chiral agent has a function of inducing a screw structure of a cholesteric liquid crystal phase. The chiral compound may be selected depending on the purposes since the induced sense of the screw or the induced spiral pitch is different according to the compound.

The chiral agent is not particularly limited, and the well-known compound (for example, disclosed in Liquid crystal device hand book, Chapter 3, Section 4-3, Chiral agent for TN and STN, page 199, Japan Society for the Promotion of Science, edited by The 142-Committee, 1989), isosorbide, and an isomannide derivative can be used.

The chiral agent generally includes an asymmetric carbon atom, but an axial asymmetric compound or a flat asymmetric compound which does not an asymmetric carbon atom can be also used as a chiral agent. Examples of an axial asymmetric compound or a flat asymmetric compound include binaphthyl, helicene, paracyclophane, and derivatives thereof. The chiral agent may have a polymerizable group. If the chiral agent and the curable cholesteric liquid crystal compound have a polymerizable group, a polymer having a repeating unit derived from a cholesteric liquid crystal compound and a repeating unit derived from a chiral agent can be formed by the polymerization reaction with the polymerizable chiral agent and the polymerizable cholesteric liquid crystal compound. In this embodiment, the polymerizable group having the polymerizable chiral agent is preferably a group in the same type of the polymerizable group included in the polymerizable cholesteric liquid crystal compound. Accordingly, the polymerizable group of the chiral agent is also preferably an unsaturated polymerizable group, an epoxy group, or an aziridinyl group, more preferably an unsaturated polymerizable group, and particularly preferably an ethylenically unsaturated polymerizable group.

In addition, the chiral agent may be a liquid crystal compound.

If the chiral agent has a photoisomerizing group, it is preferable, since a pattern having a desired reflection wavelength corresponding to the emision wavelength can be formed by photomask irradiation such as active rays after the coating and alignment. As the photoisomerizing group, an isomerized portion of a compound exhibiting photochromicity, azo, azoxy, and a cinnamoyl group are preferable. As the specific compound, the compounds disclosed in JP2002-80478A, JP2002-80851A, JP2002-179668A, JP2002-179669A, JP2002-179670A, JP2002-179681A, JP2002-179682A, JP2002-338575A, JP2002-338668A, JP2003-313189A, and JP2003-313292A can be used, the contents disclosed in these publications are incorporated in this specification.

In the liquid crystal composition, the content of the chiral agent is preferably 0.01 mol % to 200 mol % and more preferably 1 mol % to 30 mol % with respect to the polymerizable liquid crystal compound amount.

Polymerization Initiator

The liquid crystal composition preferably contains a polymerization initiator. In the embodiment in which the polymerization reaction is advanced by the ultraviolet ray irradiation, the polymerization initiator used is preferably a photopolymerization initiator that can initiate polymerization reaction by ultraviolet ray irradiation. Examples of the photopolymerization initiator include an α-carbonyl compound (disclosed in U.S. Pat. No. 2,367,661A and U.S. Pat. No. 2,367,670A), acyloin ether (disclosed in U.S. Pat. No. 2,448,828A), an α-hydrocarbon-substituted aromatic acyloin compound (disclosed in U.S. Pat. No. 2,722,512A), a polynuclear quinone compound (disclosed in U.S. Pat. No. 3,046,127A and U.S. Pat. No. 2,951,758A), a combination of triarylimidazole dimer and p-amino phenyl ketone (disclosed in U.S. Pat. No. 3,549,367A), acridine and a phenazine compound (disclosed in JP1985-105667A (JP-S60-105667A) and U.S. Pat. No. 4,239,850A) and an oxadiazole compound (disclosed in U.S. Pat. No. 4,212,970A), and the contents disclosed in these publications are incorporated in this specification.

The content of the photopolymerization initiator in the liquid crystal composition is preferably 0.1 mass % to 20 mass % and more preferably 0.5 mass % to 5 mass % with respect to the content of the polymerizable liquid crystal compound.

Crosslinking Agent

The liquid crystal composition may optionally contain a crosslinking agent in order to enhance film strength after curing and durability. As the crosslinking agent, a crosslinking agent that performs curing with ultraviolet ray, heat, humidity, or the like can be suitably used.

The crosslinking agent is not particularly limited and can be easily selected depending on the purposes, and examples thereof include a multifunctional acrylate compound such as trimethylolpropane tri(meth)acrylate, and pentaerythritol tri(meth)acrylate; an epoxy compound such as glycidyl (meth)acrylate and ethylene glycol diglycidyl ether; an aziridine compound such as 2,2-bishydroxymethylbutanol-tris[3-(1-aziridinyl) propionate], and 4,4-bis(ethylene iminocarbonyl amino) diphenylmethane; an isocyanate compound such as hexamethylene diisocyanate and biuret type isocyanate; a polyoxazoline compound having an oxazoline group in a side chain; and an alkoxysilane compound such as vinyl trimethoxysilane and N-(2-aminoethyl)-3-amino-propyl trimethoxysilane. In addition, according to the reactivity of the crosslinking agent, a well-known catalyst can be used, and thus, productivity can be enhanced in addition to the enhancement of the film strength and the durability. These may be used singly or two or more types thereof may be used in combination.

The content of the crosslinking agent is preferably 3 mass % to 20 mass % and more preferably 5 mass % to 15 mass %. If the content of the crosslinking agent is less than 3 mass %, an effect of crosslinking density enhancement may not be obtained, and if the content thereof is greater than 20 mass %, the stability of the cholesteric layer may be decreased. The content of the crosslinking agent is preferably adjusted in order to obtain necessary flexibility of the cholesteric liquid crystal layer.

Alignment Controlling Agent

An alignment controlling agent that stably or promptly contributes to a cholesteric liquid crystal layer having planar alignment can be added to the liquid crystal composition. Examples of the alignment controlling agent include a fluorine (meth)acrylate-based polymer disclosed in paragraphs “0018” to “0043” in JP2007-272185A and compounds expressed by Formulae (I) to (IV) disclosed in paragraphs “0031” to “0034” of JP2012-203237A, and the contents disclosed in these publications are incorporated in this specification.

In addition, the alignment controlling agent may be used singly or two or more types thereof may be used in combination.

In the liquid crystal composition, the addition amount of the alignment controlling agent is preferably 0.01 mass % to 10 mass %, more preferably 0.01 mass % to 5 mass %, and particularly preferably 0.02 mass % to 1 mass % with respect to total mass of the cholesteric liquid crystal compound.

Other Additives

In addition, the liquid crystal composition may contain at least one type selected from various additives such as a surfactant for adjusting a surface tension of a coated film so as to cause the film thickness to be even, a polymerizable monomer, and the like. In addition, a polymerization inhibitor, an antioxidant, an ultraviolet ray absorbing agent, a light stabilizer, a colorant, and metal oxide fine particles may be further added to the liquid crystal composition, if necessary, in the range of not decreasing optical performance.

With respect to the cholesteric liquid crystal layer, the liquid crystal composition obtained by dissolving the polymerizable liquid crystal compound and the polymerization initiator, and the chiral agent and the surfactant which are added, if necessary, in the solvent is applied to the substrate and dried to obtain the coated film, the coated film is irradiated with the active rays so as to polymerize the cholesteric liquid crystalline composition, and thus, the cholesteric liquid crystal layer in which cholesteric regularity is fixed can be formed. In addition, the laminate film formed with plural cholesteric layers can be formed by repeatedly performing the step of manufacturing the cholesteric layer.

The solvent used in the preparation of the liquid crystal composition is not particularly limited, and can be appropriately selected depending on the purposes, but an organic solvent is preferably used.

The organic solvent is not particularly limited, but can be appropriately selected depending on the purposes, and thus, examples thereof include ketones, alkyl halides, amides, sulfoxides, a heterocyclic compound, hydrocarbons, esters, and ethers. These may be used singly or two or more types thereof may be used in combination. Among these, considering environmental impact, ketones are particularly preferable.

The method of applying the liquid crystal composition to the substrate is not particularly limited and can be appropriately selected depending on the purposes. Examples thereof include a wire bar coating method, a curtain coating method, an extrusion coating method, a direct gravure coating method, a reverse gravure coating method, a die coating method, a spin-coating method, a dip coating method, a spray coating method, and a slide coating method. In addition, the applying method can be performed by transferring the liquid crystal composition coated on the separate support, to the substrate. The liquid crystal molecule is aligned by heating the applied liquid crystal composition. The heating temperature is preferably 200° C. or lower and more preferably 130° C. or lower. According to this alignment treatment, an optical thin film in which the polymerizable liquid crystal compound is twist-aligned so as to have a screw axis in the substantially vertical direction with respect to the film surface can be obtained.

The aligned liquid crystal compound may be further polymerized. Examples of the polymerization method include photopolymerization (ultraviolet ray polymerization), radiation polymerization, electron beam polymerization, and thermal polymerization, and any one of these may be used, but photopolymerization is preferable. In the photoirradiation, an ultraviolet ray is preferably used. The irradiation energy is preferably 20 mJ/cm² to 50 J/cm² and more preferably 100 mJ/cm² to 1,500 mJ/cm². In order to promote the photopolymerization reaction, photoirradiating may be performed under a heating condition or a nitrogen atmosphere. The irradiation ultraviolet ray wavelength is preferably 200 nm to 430 nm. The polymerization reaction rate is preferably high in view of stability but is preferably adjusted to be low in view of flexibility, and the polymerization reaction rate may be adjusted by adjusting irradiation energy, if necessary. In general, the polymerization reaction rate is preferably 60% to 100%, more preferably 70% to 95%, and further preferably 80% to 90%.

As the polymerization reaction rate, the ratio of consumption of the polymerizable functional group can be determined by using an IR absorption spectrum.

In addition, the thicknesses of the cholesteric liquid crystal layer used as the selective reflection layer or the circularly polarized light separating layer are preferably 1 μm to 150 μm, more preferably 2 μm to 100 μm, and further preferably 5 μm to 50 μm with respect to the total of plural layers, if the plural layers are laminated.

(Birefringence Layer)

As described above, if the stress display member according to the invention has a birefringence layer, even if the strain is less than 5%, detection by recognition becomes easy. In this specification, the birefringence layer may be a layer in which birefringence changes when a strain is generated, and may not include birefringence in an initial state before a strain is generated and time points when a strain is generated. In addition, the birefringence layer may function as a support, and examples thereof include support for forming a cholesteric liquid crystal layer, and a support for the self-supporting characteristics of the stress display member. In addition, as described above, a λ/4 phase difference layer forming the circularly polarized light separating layer may also function as a birefringence layer.

If stress display member of the second embodiment includes the birefringence layer and the circularly polarized light separating layer, the selective reflection layer, the birefringence layer, and the circularly polarized light separating layer are included in the stress display member, in this sequence.

The film thickness of the birefringence layer is not particularly limited, but the film thickness may be a value which is suitable for detection by adjusting birefringence (phase difference amount) by adjustment of the film thickness. The birefringence layer is preferably thick, since the phase difference increases, and thus, measuring sensitivity of the stress increases. However, when the birefringence layer is attached to the object to be used as the strain measuring film, if the birefringence layer becomes too thick, the birefringence layer may become resistant to deformation of the target due to the rigidity of the stress display member, and thus, the original strain amount may not be measured. Therefore, in view of accurately measuring the strain of the target, it is preferable that the birefringence layer is as thin as possible. In this point of view, the film thickness of the birefringence layer is 1000 μM or less, preferably 500 μm or less, more preferably 300 μm or less, and further preferably 100 μm or less. Meanwhile, if the film thickness is too small, work of adhering the birefringence layer to the target becomes slightly difficult, and thus, the film thickness of the birefringence layer when there is no support is preferably 1 μm or greater, more preferably 5 μm or greater, and particularly preferably 15 μm or greater. However, when the birefringence layer is laminated on the support, adhering work can be enhanced due to the rigidity of the support, and thus, the film thickness of the birefringence layer can be caused to be 1 μm or less.

If the λ/4 phase difference layer in the circularly polarized light separating layer is used as the birefringence layer, the film thickness may be a predetermined thickness required as the λ/4 phase difference layer in order to exhibit the function as the circularly polarized light separating layer.

The birefringence layer preferably has a great absolute value of the photoelastic coefficient. In the stress display member according to the second embodiment, the sign of the photoelastic coefficient of the birefringence layer is different from the sign of the phase difference occurring in the birefringence layer, but the absolute value of the photoelastic coefficient influences the detection sensitivity of the stress (strain). If the birefringence layer of which the absolute value of the photoelastic coefficient is great is used, great birefringence (phase difference) can occur due to a small amount of stress, and thus, sensitivity for detecting and measuring the stress can be increased. The absolute value of the photoelastic coefficient of the birefringence layer is preferably 20×10⁻¹² [Pa^{-1/2}] or greater. The fact that the absolute value of the photoelastic coefficient is 20×10⁻¹² [Pa^{-1/2}] or greater means that the photoelastic birefringence layer is preferably thinner, the absolute value of the photoelastic coefficient is more preferably 30×10¹² [Pa⁻¹] or greater and further preferably 60×10⁻¹² [Pa^{-1/2}] or greater, in order to cause the phase difference to be great. The upper limit of the absolute value of the photoelastic coefficient of the birefringence layer is not particularly limited, but may be 1×10⁻⁶ [Pa^{-1/2}] or less. The fact that the absolute value of the photoelastic coefficient is 1×10⁻⁶ [Pa⁻¹] or less means that the photoelastic coefficient is −1×10⁻⁶ Pa^{-1/2} to 1×10⁶ Pa^{-1/2}.

Examples of the birefringence layer include gelatin, epoxy resin, polyimide, polycarbonate, polyethylene terephthalate, glycol-modified polyethylene terephthalate (PETG), polyamide, polyvinyl alcohol, triacetyl cellulose, polystyrene, and polymethylmethacrylate. 2 or more types of the birefringence layer may be laminated to be used. In the case of the stress display member of the second embodiment, the determination of the stress becomes easier by using the light shielding layer, if necessary, and designing the light shielding layer to be black in an initial state in which stress is not generated such that reflectance of predetermined light increases due to the generation of the stress. Therefore, the birefringence in the state in which stress is not generated is preferably small in design, and polyimide, polycarbonate, or glycol-modified polyethylene terephthalate which is distributed as a generic birefringence layer is suitable. In addition, the visible light transmittance of the birefringence layer is preferably high, and the visible light transmittance is preferably 50% or greater, 70% or greater, 90% or greater, and 99% or greater.

As the method of laminating the selective reflection layer or the circularly polarized light separating layer on the birefringence layer, an existing method can be used, and, for example, an applying method, a co-extrusion method, an evaporation method, and a pasting method can be used. In addition, an easily adhesive layer, antistatic layer, a solvent resistant layer, an alignment layer, a scratch resistance layer, an anti-reflective layer, a UV absorbing layer, a gas barrier layer, a transparent conductive layer, an adhesive layer, a plasma surface treating layer, and the like may be laminated on the surface of the birefringence layer. The thicknesses of these layers are preferably thin and preferably 10 μm or less.

(Circularly Polarized Light Separating Layer and Circularly Polarized Light Separating Film)

As described above, in the case of the stress display member of the second embodiment, the stress display member according to the invention may have the circularly polarized light separating layer. In addition, the strain detection may be performed through the circularly polarized light separating film. Hereinafter, the circularly polarized light separating layer is described. As the circularly polarized light separating film, a film having the same configuration as the circularly polarized light separating layer can be used.

The circularly polarized light separating layer is a layer that selectively transmits the circularly polarized light having any one sense of the right-handed circularly polarized light and the left-handed circularly polarized light in the specific wavelength region.

The specific wavelength region in which the circularly polarized light separating layer selectively transmits circularly polarized light may be selected in accordance with the selective reflection wavelength of the selective reflection layer. For example, if the selective reflection wavelength of the selective reflection layer is in the visible light region, the specific wavelength region in which the circularly polarized light separating layer selectively transmits the circularly polarized light is 350 nm to 850 nm, and the specific wavelength region is preferably in the visible light region of 380 nm to 780 nm. In addition, the wavelength region width thereof is 5 nm or greater, 10 nm or greater, 20 nm or greater, 30 nm or greater, 40 nm or greater, or 50 nm or greater. The sense of the circularly polarized light that is selectively transmitted by the circularly polarized light separating layer may be the same as or the reverse of the sense of the circularly polarized light that is selectively reflected by the selective reflection layer. For example, a case where the stress display member according to the invention is attached to the object and used as the strain measuring film, and a case where a phase difference (Re) is about 10 nm or less in a state in which the birefringence layer has no strain and Re increases if a strain is generated, are considered. If the sense of the circularly polarized light that is transmitted by the circularly polarized light separating layer and the sense of the reflected light (circularly polarized light) in the selective reflection layer are identical to each other, the film is bright in a state in which a strain is not generated and dark in a state in which a strain is generated. Meanwhile, the sense of the circularly polarized light that is transmitted by the circularly polarized light separating layer is the reverse of the sense of the reflected light (circularly polarized light) of the selective reflection layer, the film is dark in a state in which the strain is not generated and bright in a state in which the strain is generated.

The circularly polarized light separating layer may transmit, reflect, or absorb the light in the wavelength out of the wavelength region in which any one of the right-handed circularly polarized light or the left-handed circularly polarized light is selectively transmitted. In addition, the circularly polarized light separating layer selectively transmits any one of the right-handed circularly polarized light or the left-handed circularly polarized light and may also reflect or absorb the other circularly polarized light.

As the circularly polarized light separating layer, for example, a cholesteric liquid crystal layer or a laminated body obtained by laminating a linearly polarized light separating layer and a λ/4 phase difference layer can be used.

(Cholesteric Liquid Crystal Layer Used as Circularly Polarized Light Separating Layer)

When the cholesteric liquid crystal layer which is used as the circularly polarized light separating layer is used, the spiral pitch of at least one cholesteric liquid crystal layer included in the circularly polarized light separating layer is preferably identical to the spiral pitch of at least one cholesteric liquid crystal layer included in the selective reflection layer. At least, the spiral pitch of at least one cholesteric liquid crystal layer included in the circularly polarized light separating layer is preferably adjusted so as to selectively transmit the circularly polarized light in the wavelength region including the wavelength of the circularly polarized light that selectively reflected by the cholesteric liquid crystal layer in the selective reflection layer. The circularly polarized light separating layer and the selective reflection layer are identical to each other in view of the composition, the film thickness, and the manufacturing method. Meanwhile, the senses of the screws of the at least one cholesteric liquid crystal layer included in the circularly polarized light separating layer and the at least one cholesteric liquid crystal layer included in the selective reflection layer are may be identical to or reversed. The circularly polarized light separating layer of the cholesteric liquid crystal can be caused to be thinner than the layer obtained by laminating the linearly polarized light layer and the λ/4 phase difference layer and thus, is suitable as the strain measuring film.

If the circularly polarized light separating layer is made of one cholesteric liquid crystal layer, stress can be detected as brightness of the reflected light in the specific wavelength corresponding to the spiral pitch of the cholesteric liquid crystal layer.

(Laminated Body Including Linearly Polarized Light Separating Layer and λ/4 Phase Difference Layer)

In the circularly polarized light separating layer made of the laminated body including the linearly polarized light separating layer and the λ/4 phase difference layer, the natural light incident from the surface of the linearly polarized light separating layer is converted to the linearly polarized light due to the reflection or absorption, and converted to right-handed or left-handed circularly polarized light by passing through the λ/4 phase difference layer thereafter. Meanwhile, in the case of the light incidence from the λ/4 phase difference layer, only the circularly polarized light in some senses is converted to the linearly polarized light in a direction of transmitting the linearly polarized light separating layer so as to transmit. Therefore, in the use in the stress display member according to the invention, the stress display member is preferably used such that the linearly polarized light separating layer is positioned on the external side (light source side) seen from the λ/4 phase difference layer.

As the linearly polarized light separating layer, the linear polarizer can be used, and the linearly polarized light separating layer may be a polarizer corresponding to the selective reflection wavelength of the selective reflection layer.

(Linear Polarizer)

As the linear polarizer, an iodine-based polarizer, a dye-based polarizer using a dichromatic dye, or a polyene-based polarizer can be used. An iodine-based polarizer and a dye-based polarizer are generally manufactured by using a polyvinyl alcohol-based film. For example, the polarizer is preferably formed with modified or unmodified polyvinyl alcohol and a dichromatic molecule. With respect to the polarizer formed with modified or unmodified polyvinyl alcohol and the dichromatic molecule, for example, disclosure in JP2009-237376A can be referred to.

In addition to the linear polarizer, reflection-type linear polarizers disclosed in paragraphs 0014-0023 of JP2012-223163A may be used.

The film thickness of the linearly polarized light separating layer may be 0.05 μm to 300 μm, particularly 50 μm or less, preferably 30 μm or less, and more preferably 20 μm or less. In addition, the film thickness of the polarizer may be generally 1 μM or greater, 5 μm or greater, or 10 μm or greater.

(λ/4 Phase Difference Layer)

The in-plane slow axis of the λ/4 phase difference layer is installed in the position which rotates by 45° from the absorption axis or the transmitting axis of the linear polarizer. The phase difference of the λ/4 phase difference layer is desirably the ¼ length of the selective reflection wavelength of the selective reflection layer and “¼ (n is an integer) of the selective reflection wavelength*n±central wavelength”. For example, if the selective reflection wavelength is 500 nm, the phase difference is preferably 125 nm, 375 nm, or 625 nm. In addition, the dependency of the light incident angle of the phase difference is preferably small, and the phase difference plate having the phase difference of the ¼ length of the central wavelength is most is most preferable in this point of view.

Examples of the material of the λ/4 phase difference layer include crystalline glass, a crystal of an inorganic substance, polycarbonate, an acrylic resin, polyethylene, polyester, an epoxy resin, polyurethane, polyamide, polyolefin, a cellulose derivative, silicone (including modified silicone such as silicone polyurea), a polymer such as a cycloolefin polymer and polymethyl methacrylate, or a product obtained by arranging and fixing a polymerizable liquid crystal compound and a high molecular liquid crystal compound.

The thickness of the λ/4 phase difference layer is preferably 0.2 μm to 300 μm, more preferably 0.5 μm to 150 μm, and further preferably 1 μm to 80 μm.

(Light Shielding Layer)

The ability of the reflected light from the stress display member to be recognized can be enhanced by providing the light shielding layer of the stress display member on the surface side opposite to the surface which is irradiated with light and additionally can be caused not to be influenced by the color of the target. Instead of being provided in the stress display member or in addition to being provided in the stress display member, the light shielding layer may be used by being pasted to the target as the light shielding film.

The light shielding layer preferably blocks natural light. In addition, all of non-polarized light, circularly polarized light, and linearly polarized light are preferably blocked. The wavelength region in which the light shielding layer blocks light may be selected based on the selective reflection wavelength of the selective reflection layer of the stress display member and may be a wavelength region including the selective reflection wavelength of the cholesteric liquid crystal layer. For example, the wavelength region is at least a portion of the wavelength region of 380 nm to 780 nm, and the wavelength width may be 10 nm or greater, 20 nm or greater, 30 nm or greater, 40 nm or greater, 50 nm or greater, or the like. At least a portion of the visible light wavelength region is 50% or greater, 60% or greater, 70% or greater, 80% or greater, or 90% or greater of the wavelength region of 380 nm to 780 nm, and is substantially 100%.

The forming of the light shielding layer can be performed in the well-known method, and, for example, an applying method, a co-extrusion method, an evaporation method, and a pasting method can be used. The surface of the stress display member is caused to have high haze and may be the light shielding layer.

The optical density (OD value) of the light shielding layer is preferably of 0.5 or greater, more preferably 1 or greater, and particularly preferably 2 or greater. The optical density is a value indicating transmittance of light, indicates attenuation of the transmitted light, and is indicated by −log₁₀ T if the transmittance is represented by T. If the selective reflection wavelength of the selective reflection layer is visible light, the OD value may be in the range described above in the wavelength region of 350 nm to 850 nm.

The film thickness of the light shielding layer is preferably 0.1 μm to 100 μm, more preferably 0.2 μm to 50 μm, and particularly preferably 0.5 μm to 30 μM.

Examples of the light shielding layer include a light reflecting layer and a light absorbing layer. If the contrast with the color observed by the strain detection is considered, the light absorbing layer recognized as black is preferably used.

As the light reflecting layer, a layer including a dielectric multilayer or a cholesteric liquid crystal layer can be used. As the layer including a cholesteric liquid crystal layer which is the light reflecting layer, a laminated body including a cholesteric liquid crystal layer having the right sense of the screw and a cholesteric liquid crystal layer having the left sense of a screw, which have the same pitch length P of the screw structure and a laminated body including the same cholesteric liquid crystal layers which have the same pitch length P of the screw structure and the same sense of the screw and a phase difference layer having the phase difference having the half wavelength with respect to the central wavelength of the circularly polarized light reflection of the cholesteric liquid crystal layer which is interposed between the cholesteric liquid crystal layers, can be used. As the light absorbing layer, a layer formed by applying a dispersion liquid obtained by dispersing a colorant such as a pigment or a dye in a solvent including a dispersing agent, a binder, or a monomer to a substrate, a layer obtained by directly dying the surface of a high molecular substrate by using a dye, or a layer formed with a high molecular material including a dye can be used. In the pigment of the black light absorbing layer, for example, carbon black and the like can be used. As the carbon black, various products of oil furnace black, channel black, lampblack, thermal black, acetylene black, and the like are known, and all are used.

(Adhesive Layer and Adhesive Agent)

The stress display member preferably has an adhesive layer for an embodiment in which the stress display member is attached to the target and is enabled to be used for strain measurement. In the above function, the adhesive layer is preferably an outermost layer with respect to all of the selective reflection layer, the birefringence layer, the circularly polarized light separating layer, and the light shielding layer. However, until the stress display member is attached to the target, a mold release paper (film) for protecting the adhesive layer on the further outer side of the adhesive layer may be included. In the stress display member according to the first embodiment, the adhesive layer may be provided to the outermost layer on any side or the adhesive layer side is attached to the target and so as to perform strain measurement from the opposite side. Meanwhile, in the stress display member according to the second embodiment, the birefringence layer, the selective reflection layer, the adhesive layer are laminated on the outermost layer in this sequence, and thus, the adhesive layer side is attached to the target so as to perform strain measurement from the birefringence layer.

Examples of the adhesive layer include a layer formed of a thermosetting adhesive agent such as a cyanoacrylate-based adhesive, an epoxy-based adhesive, a polyester-based adhesive, a phenol-based adhesive, a urethane-based adhesive, and a melamine-based adhesive. These adhesive agents are preferable in view of decreasing influence of the adhesive layer on the strain measuring accuracy due to creep phenomenon. If there is a support between the selective reflection layer and the target, the support becomes a stress alleviating layer to cause an error of the strain measurement. Therefore, it is preferable that the adhesive layer is directly laminated on the selective reflection layer side and is adhered to the target in view of the measuring accuracy. However, if the stress display member has the light shielding layer, the light shielding layer is provided between the selective reflection layer and the adhesive layer.

After the support is peeled off after the stress display member is adhered to the target, the rigidity of the stress display member is caused to be small such that the stress display member easily track the strain of the object to be measured.

The stress display member may not have the adhesive layer, and if the stress display member is attached to the target, the adhesive agent is separately prepared to be attached. At this point, in addition to the same adhesive agents at the time of forming the adhesive layer, various adhesive agents can be used. However, it is preferable that the adhesive layer is laminated in advance in the stress display member in order to prevent the deterioration of the workability when the stress display member is attached to the target having a large surface area or prevent the deterioration of the measuring accuracy due to the generation of the wrinkles or breakage in the stress display member at the time of the application. If the mold release paper (film) is laminate on the adhesive layer, workability becomes satisfactory by peeling off the mold release paper (film) right before the stress display member is attached to the target. If an adhesive layer in which a microcapsulated curing agent is dispersed in the main agent of the adhesive agent is laminated, adhering properties are not exhibited until the stress display member is pasted to the target, and adhering properties can be exhibited by breaking microcapsules by applying pressure with fingers or the like after pasting.

The adhesive layer may also function as the light shielding layer.

(Support)

The stress display member according to the invention may include a support. The support is not particularly limited, but a plastic film is preferably used. The support also may function as the birefringence layer. It is preferable that the support is generally transparent. If the support does not also function as the birefringence layer, the support preferably has low birefringence. Examples of the plastic film include polyester such as polyethylene terephthalate (PET), an acrylic resin, an epoxy resin, polyurethane, polyamide, polyolefin, a cycloolefin polymer, a cellulose derivative, and silicone in addition to the substances exemplified as the birefringence layer. In addition, an easily adhesive layer, an antistatic layer, a solvent resistant layer, an alignment layer, a scratch resistant layer, an antireflection layer, a UV absorbing layer, a gas barrier layer, a transparent conductive layer, an adhesive layer, a plasma surface-treated layer, and the like are laminated on the surface of the support.

The film thickness of the support is about 5 μm to 1,000 μm, preferably 10 μm to 250 μm and more preferably 15 μm to 90 μm.

The support is generally used for the manufacturing of the cholesteric liquid crystal layer, but the support at the point may be peeled off in the stress display member according to the invention. That is, for example, the cholesteric liquid crystal layer formed on the support may be transferred to the birefringence layer (for example, a polycarbonate layer). Depending on the stress display member, characteristics such as the heat resisting properties of the support can be conveniently selected for the manufacturing of the cholesteric liquid crystal layer and also optical properties of the stress display member or the like can be caused not to be influenced by the properties of the support by peeling off the support at the time of manufacturing the cholesteric liquid crystal layer. For example, a preferable screw-shaped alignment can be realized by applying the composition including the polymerizable liquid crystal compound after the support is rubbed, but sufficient alignment may not be obtained in all supports. Therefore, the stress display member according to the purpose can be manufactured by pasting or transferring the polymerizable cholesteric liquid crystal layer to the birefringence layer appropriate for the stress measuring after the cholesteric liquid crystal layer is manufactured on the alignable support.

Chemical resistance is required when the cholesteric liquid crystal layer is laminated on the support in an application method or a pasting method, and thus, a solvent resistant layer may be laminated on the surface of the support. As a solvent resistant layer, an existing material can be used, but polyvinyl alcohol or glycol-modified polyethylene terephthalate is preferable in order to cause the solvent resistant layer to also function as an alignment film described below.

(Alignment layer)

The stress display member according to the invention may include an alignment layer for aligning the liquid crystal compound. The alignment layer can be provided in the means of a rubbing treatment of an organic compound, a polymer (a resin such as polyimide, polyvinyl alcohol, polyester, polyarylate, polyamideimide, polyetherimide, polyamide, and modified polyamide), oblique vapor deposition of an inorganic compound, forming of a layer having microgroove, or accumulation of an organic compound (for example, an w-tricosanoic acid, dioctadecylmethylammonium chloride, and methyl stearate) by a Langmuir-Blodgett method (LB film). Further, an alignment layer in which an alignment function is generated due to an application of an electric field, an application of a magnetic field, or photoirradiation is known. Among these, an alignment layer formed by a rubbing treatment of a polymer is particularly preferable. The rubbing treatment can be performed several times on the surface of the polymer layer in a constant direction with paper or fabric.

The thickness of the alignment layer is preferably 0.01 μm to 5 μm and further preferably 0.05 μM to 2 μm.

A liquid crystal composition can be applied on the surface of the support without providing an alignment layer or on the surface obtained by performing a rubbing treatment on the support.

(Adhesive Layer for Adhering Respective Layers)

In view of the curing method, examples of the adhesive agent for adhering respective layers in the stress display member include the hot melt type, the thermosetting type, the photocuring type, the reaction curing type, and the pressure sensitive adhering type which does not need curing, and as the respective materials, a compound based on acrylate, urethane, urethane acrylate, epoxy, epoxy acrylate, polyolefin, modified olefin, polypropylene, ethylene vinyl alcohol, vinyl chloride, a chloroprene rubber, cyano acrylate, polyamide, polyimide, polystyrene, and polyvinylbutyral are used. In view of workability and productivity, a photocuring type is preferable as the curing method, and in view of optical transparency and heat resisting properties, as the material, compounds based on acrylate, urethane acrylate, epoxy acrylate, and the like are preferably used.

(Manufacturing of Stress Display Member)

Since all the respective layers forming the stress display member according to the invention can be manufactured by Roll to Roll, the stress display member according to the invention can be easily mass-produced in a large surface area.

(Strain Measurement Method)

The stress display member according to the invention is attached to the target and can be used for strain measuring of the target. The strain is measured by applying light in the wavelength including the selective reflection wavelength of the selective reflection layer, and detecting the reflected light or the transmitted light thereof visually or with a measuring device. In addition, the detected light is preferably reflected light. This is because the detection using the transmitted light is limited to a case where the target has sufficient light transmittance (50% or greater and preferably 90% or greater) of the selective reflection wavelength light of the selective reflection layer, and the detected light is easily influenced by optical characteristics of the adhesive layer, the color of the target, and the like.

In the strain measurement using the stress display member according to the second embodiment, the light may be incident to the circularly polarized light separating layer (circularly polarized light separating film), the birefringence layer, and the selective reflection layer in this sequence from the light source. As described above, the stress display member according to the invention may include the circularly polarized light separating layer, the circularly polarized light separating film may be separately used, and the light source itself may apply the circularly polarized light.

If the strain measurement of the target is performed by attaching the stress display member to the target, the stress display member according to the first embodiment may be measured from any one of the both surfaces of the stress display member, and thus, any one of the both surfaces of the stress display member may be attached to the target. The light is incident from the surface side (the surface side which is attached to the stress display member in the target) of the stress display member which is opposite to the surface to which the target is attached, and the reflected light can be measured. In addition, if the target is a transparent body, the light from the surface side (surface side opposite to the surface to which the stress display member is attached in the target) of the stress display member which is attached to the target can be measured, the transmitted light can be measured from the attached surface side by causing light to be incident from the attached surface, and the reflected light can be measured from the opposite side of the attached surface by causing light to be incident from the attached surface side.

If the strain amount is measured by attaching the stress display member of the second embodiment to the object (target), the stress display member is attached to the target to have the sequence of the birefringence layer, the selective reflection layer, and the target. In the same manner as in the stress display member of the first embodiment, the reflected light can be measured by causing light from the surface side (surface side to which the stress display member is attached in the target) of the stress display member on the opposite side of the surface to which the target is attached. In addition, if the target is a transparent body, light can be measured from the attached surface side (surface side which is opposite to the surface to which the stress display member is attached in the target) to the target of the stress display member, the transmitted light can be measured from the attached surface by causing light to be incident from the opposite side of the attached surface, and the reflected light can be measured from the opposite side of the attached surface by causing light to be incident from the attached surface side.

At the time of measuring the strain, there is a concern in that the color is changed by a measuring angle, and thus, a measurement error is generated. This is because the reflection wavelength originating from the cholesteric liquid crystal layer has angle dependency. Therefore, the measurement error can be reduced by restricting the viewing angle and using the viewing angle restricting film (a prism film, the Louver film, or the like). The viewing angle restricting film may be used by disposing a separate sheet on the surface of the stress display member or may be a layer forming the stress display member by being laminated on the outermost surface on the recognition side of the stress display member.

At the time of strain measurement, any one type of light such as sunlight, a fluorescent lamp, and an incandescent lamp may be used as the light source.

In the strain measurement using the stress display member according to the first embodiment, if the light having the same wavelength as the selective reflection wavelength of the selective reflection layer is measured as the light source, light from the light source is reflected when there is no stress, but reflectance decreases if stress is generated and a peak wavelength is shifted. In this manner, in the case of the single wavelength, the stress can be detected as the brightness, and in the case of 2 or more types of wavelengths, coloration of the light changes, and thus, the stress can be detected. With respect to the detection of the brightness, the sensitivity can be increased by narrowing down the wavelength region of the light applied from the light source. Particularly, the sensitivity can be raised by causing the wavelength region of the light applied from the light source to be smaller than the selective reflection wavelength bandwidth of the selective reflection layer. In other words, the half-value width (that can be calculated from the emission spectrum or the like) of the light from the light source is preferably smaller than the half-value width of the selective reflected light that can be calculated from the reflection spectrum of the selective reflection layer. Specifically, the half-value width of the light from the light source is preferably 100 nm or less and more preferably 50 nm or less.

### EXAMPLES

Hereinafter, the invention is more specifically described with reference to examples below. Materials, reagents, amounts and ratios of substances, and operations described in the examples below can be appropriately changed without departing from the gist of the invention. Accordingly, the scope of the invention is not limited to the examples below.

(Evaluating Method of Stress Display Member)

The evaluating method using respective examples are as described below.

A stress display member is pasted to a target of which a strain was to be measured was punched to a dumbbell shape and a tensile stress was applied at a speed of 5 mm/min with a tensile testing machine (STRONGRAPH-M1 manufactured by Toyo Seiki Seisaku-Sho, Ltd.).

The strain amount is calculated in the stretching amount of the strain measuring target with a tensile testing machine.

Changes of the reflection wavelength of the stress display member were measured in Examples 1 to 7, changes (brightness) of the reflectance of the stress display member were measured in Examples 8 to 17, 20, and 21, changes of the color caused by the change of the reflectance of the 2 selective reflection wavelengths in Examples 18 and 19 were measured, by applying light from the surface of the stress display member on the opposite side of the light shielding layer to the selective reflection layer.

With respect to the stress display member, visual measurement in a vertical direction and microspectroscopic spectrum measurement by a reflection-type spectroscopic apparatus (USB2000+ manufactured by Ocean Optics, Inc.) was performed to be evaluated.

In the visual evaluation, a case where a change of color or brightness of the selective reflected light of the stress display member was able to be clearly determined was A, a case where a slight change was recognized was B, and a case where a change was indistinguishable was C. In the same manner, in the evaluation of a spectrophotometer, a case where a change of a wavelength shift of selective reflected light or reflectance was able to be clearly determined was A, a case where a slight change was recognized was B, and a case where a change was indistinguishable was C.

With respect to uniformity of a color tone of a film, a case where color unevenness was not able to be visually seen and a color tone was even was A, a case where color unevenness was slightly seen and a color tone was slightly uneven was B, and a case where coloring or color unevenness was seen and a color tone was uneven, was C.

The evaluation result was presented in Table 1.

### Examples 1 to 7

### Preparation of an Application Liquid (R1) for Cholesteric Liquid Crystal Layer

A compound 1, a compound 2, a fluorine-based horizontal orientation agent, a chiral agent, a polymerization initiator, and a solvent of methyl ethyl ketone below were mixed so as to preprare the application liquid in the following composition.

| | |
|---|---|
| The compound 1 below (bifunctional) + the compound 2 (monofunctional) below | 100 parts by mass |
| (Mass ratio presented in Table 1) | |
| Fluorine-based horizontal orientation agent 1 below | 0.1 parts by mass |
| Fluorine-based horizontal orientation agent 2 below | 0.007 parts by mass |
| Right-handed chiral agent LC756 below (manufactured by BASF SE) | 6.6 parts by mass |
| Polymerization initiator IRGACURE 819 (manufactured by BASF SE) | 3 parts by mass |
| Solvent (methyl ethyl ketone) | amount such that a |
| | solute concentration |
| | became 30 mass % |

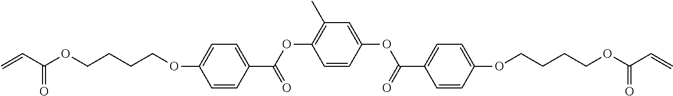 [SMILES: C=CC(=O)OCCCCOc1ccc(C(=O)Oc2ccc(OC(=O)c3ccc(OCCCCOC(=O)C=C)cc3)c(C)c2)cc1]

Compound 1 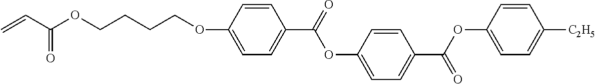 [SMILES: C=CC(=O)OCCCCOc1ccc(C(=O)Oc2ccc(C(=O)Oc3ccc(CC)cc3)cc2)cc1]
Compound 2 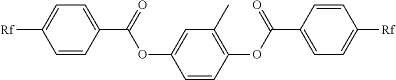 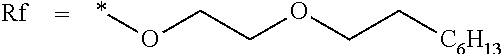
Fluorine-based horizontal orientation agent 1 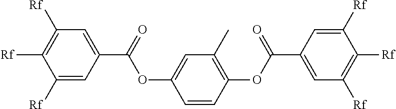 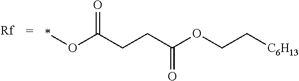
Fluorine-based horizontal orientation agent 2

<Forming of Selective Reflection Layer>

A PET film (no undercoat, manufactured by Fujifilm Corporation, thickness: 50 μm, size: 210 mm×300 mm) was used as a support, a rubbing treatment (Rayon cloth, pressure: 0.1 kgf, the number of rotations: 1,000 rpm, conveying speed: 10 m/min, and the number of times: 1 round trip) was performed on the surface of the PET film.

Subsequently, the application liquid (R1) was applied to the rubbed surface of the PET film by using a wire bar at room temperature such that the thickness of the film after drying became 5 μm. The solvent was dried for 30 seconds at room temperature so as to be removed, heating was performed for 2 minutes under the atmosphere of 90° C., and then the temperature of 35° C. was maintained, so as to form a cholesteric liquid crystal phase. Subsequently, UV irradiation was performed for 6 seconds to 12 seconds at an output of 60% with an electrodeless lamp “D valve” (90 mW/cm) manufactured by Fusion UV Systems Inc., a polymerization reaction was performed on the liquid crystal compound, the cholesteric liquid crystal phase was fixed, and a film having a cholesteric liquid crystal layer was manufactured on the PET film, so as to obtain the stress display member of Examples 1 to 7. The transmission spectrum of the stress display member of Examples 1 to 7 was measured, and the selective reflection wavelength was 454 nm.

A black vinyl tape was prepared as a target for strain measurement (VT-50 manufactured by Nichiban Co., Ltd), and a support side of a stress display member was pasted on an adhesive layer side of the black vinyl tape. Since the black vinyl tape functioned as a light shielding layer, a light shielding layer was not laminated on the stress display member.

### Examples 8 to 10

### Preparation of an Application Liquid (R2) for Cholesteric Liquid Crystal Layer

The compound 1, the compound 2, a fluorine-based horizontal orientation agent, a chiral agent, a polymerization initiator, a solvent of methyl ethyl ketone below were mixed, so as toprepare the application liquid in the composition below.

| | | |
|---|---|---|
| Compound 1 | 80 | parts by mass |
| Compound 2 | 20 | parts by mass |
| Fluorine-based horizontal | 0.1 | parts by mass |
| orientation agent 1 | | |
| Fluorine-based horizontal | 0.007 | parts by mass |
| orientation agent 2 | | |
| Right-handed Chiral agent LC756 | 6.6 | parts by mass |
| (manufactured by BASF SE) | | |
| Polymerization initiator | 3 | parts by mass |
| IRGACURE 819 | | |
| (manufactured by BASF SE) | | |

| | |
|---|---|
| Solvent (methyl ethyl ketone) | Amount such that a solute |
| | concentration became 30 mass % |

<Preparation of an Application Liquid (H1) for Alignment Layer>

The application liquid for the alignment layer in the composition described below was prepared.

| Modified polyvinyl alcohol PVA203 | 10 | parts by mass |
|---|---|---|
| (manufactured by Kuraray Co., Ltd.) | | |
| Glutaraldehyde | 0.5 | parts by mass |
| Water | 371 | parts by mass |
| Methanol | 119 | parts by mass |

<Preparation of an Application Liquid (B 1) for Light Shielding Layer>

First, Pigment dispersion (K1) in the following composition, Binder 1, Monomer 1, and Surfactant 1 were preprared.

Pigment Dispersion (K1)

| | |
|---|---|
| Carbon black (Nipex 35 manufactured by Degussa AG) | 13.1 mass % |
| Dispersing agent 1 below | 0.65 mass % |
| Polymer 1 (Random copolymer of benzyl methacrylate/methacrylic acid = 72/28 | 6.72 mass % |
| molar ratios, weight average molecular weight: 37,000) | |
| Propylene glycol monomethyl ether acetate | 79.53 mass % |

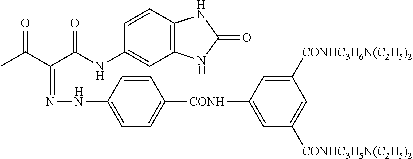

Dispersing agent 1

Binder 1

| | |
|---|---|
| Polymer 2 (Random copolymer of benzyl methacrylate/methacrylic acid = 78/22 | 27 mass % |
| molar ratios, weight average molecular weight of 38,000) | |
| Propylene glycol monomethyl ether acetate | 73 mass % |
| Monomer 1 | |
| Pentaerythritol tetraacrylate | 75 mass % |
| (NK Ester A-TMMT manufactured by Shin-Nakamura Chemical Co., Ltd.) | |
| Methyl ethyl ketone | 25 mass % |
| Surfactant 1 | |
| Compound 3 below | 30 mass % |
| Methyl ethyl ketone | 70 mass % |

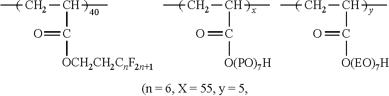

Mw = 33940, Mw/Mn = 2.55
PO: Propylene oxide, EO: Etylene oxide) Compound 3

Subsequently, an application liquid for a light shielding layer in the composition below was prepared by using pigment dispersion (K1), Binder 1, Monomer 1, and Surfactant 1.

| | | |
|---|---|---|
| Pigment dispersion (K1) | 29.2 | mass % |
| Propylene glycol monomethyl ether acetate | 8.0 | mass % |
| Methyl ethyl ketone | 32.3 | mass % |
| Cyclohexanone | 8.5 | mass % |
| Binder 1 | 15.4 | mass % |
| Phenothiazine | 0.01 | mass % |
| Monomer 1 | 6.3 | mass % |
| 2,4-bis(trichloromethyl)-6-[4′-(N,N-bis(ethoxy | 0.2 | mass % |
| vinyl methyl)amino-3′-bromophenyl]-s-triazine | | |
| Surfactant 1 | 0.1 | mass % |

<Support>

As the support that also functioned as the birefringence layer, a polypropylene film (p1128 manufactured by Toyobo Co., Ltd., thickness: 60 μm, size: 210 mm×300 mm) in Example 8, a polyethylene terephthalate film (manufactured by Fujifilm Corporation, thickness: 50 μm, size: 210 μm×300 mm) in Example 9, and a polycarbonate film (AA-50 manufactured by International Chemical Co., Ltd., thickness: 50 μm, size: 210 mm×300 mm) in Example 10 were used. Photoelastic coefficients of respective supports measured by a phase difference measuring apparatus (Spectroscopic Ellipsometer M-220 manufactured by Jasco Corporation) were as presented in Table 1.

<Forming of Selective Reflection Layer>

A plasma treatment (a normal pressure plasma surface treatment apparatus manufactured by Sekisui Chemical Co., Ltd., treating amount: 28.4 kJ/m²) was performed on one side of the support, and an application liquid (H1) for the alignment layer was applied on the plasma treatment surface by using a wire bar such that a film thickness after drying became 1.0 μm. A rubbing treatment (Rayon cloth, pressure: 0.1 kgf, the number of rotations: 1,000 rpm, conveying speed: 10 m/min, the number of times: 1 round trip) was performed on the alignment layer. Subsequently, the application liquid (R1) was applied at room temperature on the alignment layer surface subjected to the rubbing treatment by using a wire bar such that the thickness after drying became 5 μm. The solvent was removed by drying the application layer for 30 seconds, heating was performed for 2 minutes under the atmosphere of 90° C., and then the temperature of 35° C. was maintained, so as to form a cholesteric liquid crystal phase. Subsequently, UV irradiation was performed for 6 seconds to 12 seconds at an output of 60% with an electrodeless lamp “D valve” (90 mW/cm) manufactured by Fusion UV Systems Inc., polymerization reaction was performed on the liquid crystal compound, the cholesteric liquid crystal phase was fixed, and a film (F1) having a cholesteric liquid crystal layer was manufactured on the polypropylene film.

<Laminating of Light Shielding Layer>

An application liquid (B1) for the light shielding layer was applied on the cholesteric liquid crystal layer of the film (F1) by using a wire bar such that the thickness after drying became 1.1 μm. Subsequently, after the solvent was removed by drying the application layer for 2 minutes at 100° C., UV irradiation was performed for 6 seconds to 12 seconds at an output of 60% with an electrodeless lamp “D valve” (90 mW/cm) manufactured by Fusion UV Systems Inc., a light shielding layer having an optical density of 2.0 was laminated so as to obtain stress display members of Examples 8 to 10.

<Pasting Stress Display Member to Target>

The light shielding layers of the stress display members of Examples 8 to 10 were pasted to a polyester film with an adhesive material (CC-36 manufactured by Kyowa Electronic Instruments Co., Ltd.) by using a polyester film (Lumirror 500-H10 manufactured by Toray Industries, Inc., thickness: 480 μm) as a target for strain measurement.

<Measuring of Reflectance Change of Selective Reflection Wavelength Due to Stress>

A reflectance change in a selective reflection wavelength due to stress was measured by disposing a circularly polarized light filter (TCPL200 manufactured by MeCan Imaging, Inc.) on the support surfaces of the stress display members of Example 8 to 10 and applying light of a normal white fluorescent lamp (FLR40SW/M-B manufactured by Hitachi, Ltd.) to a stress display member through a circularly polarized light filter in order to cause the light source to the circularly polarized light.

### Example 11 to 13

Stress display members of Examples 11 to 13 were manufactured in the same manner as Examples 8 to 10 except for laminating the circularly polarized light filter used for the measuring of the reflectance change in Examples 8 to 10 by using the adhesive agent (CC-36 manufactured by Kyowa Electronic Instruments Co., Ltd.) on the support surface of the stress display member to be a portion of the stress display member. In the same manner as in Examples 8 to 10, the stress display members were pasted to the polyester film, so as to measure reflectance change of a selective reflection wavelength due to the stress.

### Example 14

The stress display member of Example 14 was manufactured by using the circularly polarized light filter (TCPL200 manufactured by MeCan Imaging, Inc.) instead of the polycarbonate film as the support, forming the alignment layer and the cholesteric liquid crystal layer on the λ/4 phase difference layer of the circularly polarized light filter in the same manner as in the cholesteric liquid crystal layer of Example 10, and further forming the light shielding layer in the same manner as in the light shielding layer of Example 10. Light of the normal white fluorescent lamp was applied from the linearly polarized light layer side of the circularly polarized light filter so as to measure the reflectance change.

### Examples 15 to 17

Stress display members of Example 15 to 17 were respectively manufactured by laminating the alignment layer and the cholesteric liquid crystal layer on the surface on the opposite side of the surface on which the alignment layer, the cholesteric liquid crystal layer, and the light shielding layer of the support in Examples 8 to 10, pasting the stress display members on the polyester film in the same manner as in Examples 8 to 10, and irradiating light of the normal white fluorescent lamp (FLR40SW/M-B manufactured by Hitachi Ltd.) without using the circularly polarized light filter.

### Example 18

A stress display member of Example 18 was manufactured in the same manner as in Example 17 except for laminating an additional cholesteric liquid crystal layer by using an application liquid in which the composition of the right-handed chiral agent in the application liquid (R2) for the cholesteric liquid crystal layer was 6.1 parts by mass, on the cholesteric liquid crystal layer manufactured in Example 17. The selective reflection wavelengths of two cholesteric liquid crystal layers were 454 nm and 503 nm, respectively.

### Example 19

A stress display member of Example 19 was manufactured in the same manner as in Example 17 except for laminating an additional cholesteric liquid crystal layer by using an application liquid in which the composition of the right-handed chiral agent in the application liquid (R2) for the cholesteric liquid crystal layer was 5.1 parts by mass, on the cholesteric liquid crystal layer manufactured in Example 17. The selective reflection wavelengths of two cholesteric liquid crystal layers were 454 nm and 595 nm, respectively.

### Example 20

A stress display member of Example 20 was manufactured in the same manner as in Example 17 except for laminating an additional cholesteric liquid crystal layer by using an application liquid in which the composition of the right-handed chiral agent in the application liquid (R2) for the cholesteric liquid crystal layer was 3.8 parts by mass, on the cholesteric liquid crystal layer manufactured in Example 17. The selective reflection wavelengths of two cholesteric liquid crystal layers were 454 nm and 694 nm, respectively.

### Example 21

A stress display member of Example 21 was manufactured by Roll to Roll by using a roll of a polycarbonate film (AA-50 manufactured by International Chemical Co., Ltd., thickness: 50 μm, width: 300 mm, length: 1,000 m) as the support and continuously laminating the alignment layer, the cholesteric liquid crystal layer, and the light shielding layer by application with a bar coater in the same compositions and the method of Example 10. The same measurement was performed in the same manner as in Example 10 by using the stress display member.

### Example 22

The cholesteric liquid crystal layer of the stress display member manufactured in Example 9 was pasted to polycarbonate (AA-50 manufactured by International Chemical Co., Ltd., thickness: 50 μm) by using an adhesive agent (CC-36 manufactured by Kyowa Electronic Instruments Co., Ltd.), the polyethylene terephthalate substrate of the stress display member was peeled off after being left for 24 hours, so as to manufacture the stress display member of a polycarbonate substrate. The same measurement as in Example 10 was performed by using the stress display member.

### Comparative Example 1

A stress display member was manufactured in the size of 100 mm×100 mm in the method disclosed in Example 3 of JP2006-28202A, there was color unevenness in the plane, and thus, an even stress display member was not able to be manufactured. In addition, one day was required for a drying step for self-organizing monodispersed particles and a step of curing polydimethylsilicone.

### Comparative Example 2

A stress display member was manufactured by using the composition below instead of the application liquid for the cholesteric liquid crystal layer in the same method of Example 1, a color was changed according to a temperature, and thus, the manufactured stress display member was not appropriate for the use as the stress display member.

| | |
|---|---|
| Cholesteryl oleyl carbonate | 55 mass % |
| Cholesteryl chloride | 31 mass % |
| Cholesteryl 4-n-butoxyphenyl carbonate | 14 mass % |

TABLE 1

| | | | | | | | | | | | | Strain amount: 5% or | | |
|---|---|---|---|---|---|---|---|---|---|---|---|---|---|---|
| | | | | | | | | | | | | more (Strain amount or | | |
| | | | | | | | | | | Strain amount: | | less in which cracks are | | |
| | | | | Circularly | | | | | | less than 5% | | generated) | | Strain |
| | | | Selective | polarized | Photoelastic | Thickness | | Influence | Uniformity | Evaluation | | Evaluation | | amount in |
| | | | reflection | light | coefficient of | of stress | | of | of color | of | | of | | which |
| | | Bifunctional/ | peak | separating | birefringence | display | Light | external | tone of | measuring | Visual | measuring | Visual | cracks are |
| | Type | monofunctional | wavelength | layer | layer | member | source | temperature | film | device | determination | device | determination | generated |
| Example 1 | Polymerizable | 20/80 | 454 nm | — | PET | 55 μm | Normal | No | C | | | | | |
| | cholesteric liquid | | | | (SUPPORT) | | white | influence | | | | | | |
| | crystal | | | | | | fluorescent | | | | | | | |
| | | | | | | | lamp | | | | | | | |
| Example 2 | | 30/70 | 454 nm | — | PET | 55 μm | Normal | | B | B | C | A | B | 32% |
| | | | | | (SUPPORT) | | white | | | | | | | |
| | | | | | | | fluorescent | | | | | | | |
| | | | | | | | lamp | | | | | | | |
| Example 3 | | 40/60 | 454 nm | — | PET | 55 μm | Normal | | A | B | C | A | B | 28% |
| | | | | | (SUPPORT) | | white | | | | | | | |
| | | | | | | | fluorescent | | | | | | | |
| | | | | | | | lamp | | | | | | | |
| Example 4 | | 80/20 | 454 nm | — | PET | 55 μm | Normal | | A | B | C | A | B | 25% |
| | | | | | (SUPPORT) | | white | | | | | | | |
| | | | | | | | fluorescent | | | | | | | |
| | | | | | | | lamp | | | | | | | |
| Example 5 | | 90/10 | 454 nm | — | PET | 55 μm | Normal | | A | B | C | A | B | 22% |
| | | | | | (SUPPORT) | | white | | | | | | | |
| | | | | | | | fluorescent | | | | | | | |
| | | | | | | | lamp | | | | | | | |
| Example 6 | | 95/5 | 454 nm | — | PET | 55 μm | Normal | | A | B | C | A | B | 21% |
| | | | | | (SUPPORT) | | white | | | | | | | |
| | | | | | | | fluorescent | | | | | | | |
| | | | | | | | lamp | | | | | | | |
| Example 7 | | 100/0 | 454 nm | — | PET | 55 μm | Normal | | A | B | C | A | B | 20% |
| | | | | | (SUPPORT) | | white | | | | | | | |
| | | | | | | | fluorescent | | | | | | | |
| | | | | | | | lamp | | | | | | | |
| Example 8 | Polymerizable | 80/20 | 454 nm | — | PP | 65 μm | Circularly | No | A | C | C | B | B | |
| | cholesteric liquid | | | | −18 × 10⁻¹² | | polarized | influence | | | | | | |
| | crystal | | | | | | light | | | | | | | |
| Example 9 | | 80/20 | 454 nm | — | PET | 55 μm | Circularly | No | A | A | A | A | A | |
| | | | | | 38 × 10⁻¹² | | polarized | influence | | | | | | |
| | | | | | | | light | | | | | | | |
| Example 10 | | 80/20 | 454 nm | — | PC | 55 μm | Circularly | No | A | A | A | A | A | |
| | | | | | 88 × 10⁻¹² | | polarized | influence | | | | | | |
| | | | | | | | light | | | | | | | |
| Example 11 | | 80/20 | 454 nm | Circularly | PP | 365 μm | Normal | No | A | C | C | B | B | |
| | | | | polarized | −18 × 10⁻¹² | | white | influence | | | | | | |
| | | | | light filter | | | fluorescent | | | | | | | |
| | | | | | | | lamp | | | | | | | |
| Example 12 | | 80/20 | 454 nm | Circularly | PET | 355 μm | Normal | No | A | A | A | A | A | |
| | | | | polarized | 38 × 10⁻¹² | | white | influence | | | | | | |
| | | | | light filter | | | fluorescent | | | | | | | |
| | | | | | | | lamp | | | | | | | |
| Example 13 | | 80/20 | 454 nm | Circularly | PC | 355 μm | Normal | No | A | A | A | A | A | |
| | | | | polarized | 88 × 10⁻¹² | | white | influence | | | | | | |
| | | | | light filter | | | fluorescent | | | | | | | |
| | | | | | | | lamp | | | | | | | |
| Example 14 | | 80/20 | 454 nm | Circularly | — | 305 μm | Normal | No | A | B | C | A | B | |
| | | | | polarized | | | white | influence | | | | | | |
| | | | | light filter | | | fluorescent | | | | | | | |
| | | | | (λ/4 PC) | | | lamp | | | | | | | |
| Example 15 | | 80/20 | 454 nm | Cholesteric | PP | 60 μm | Normal | No | A | C | C | B | B | |
| | | | | liquid | −18 × 10⁻¹² | | white | influence | | | | | | |
| | | | | crystal | | | fluorescent | | | | | | | |
| | | | | | | | lamp | | | | | | | |
| Example 16 | | 80/20 | 454 nm | Cholesteric | PET | 60 μm | Normal | No | A | A | B | A | A | |
| | | | | liquid | 38 × 10⁻¹² | | white | influence | | | | | | |
| | | | | crystal | | | fluorescent | | | | | | | |
| | | | | | | | lamp | | | | | | | |
| Example 17 | | 80/20 | 454 nm | Cholesteric | PC | 60 μm | Normal | No | A | A | B | A | A | |
| | | | | liquid | 88 × 10⁻¹² | | white | influence | | | | | | |
| | | | | crystal | | | fluorescent | | | | | | | |
| | | | | | | | lamp | | | | | | | |
| Example 18 | | 80/20 | 454 nm, | Cholesteric | PC | 70 μm | Normal | No | A | B | C | A | B | |
| | | | 503 nm | liquid | 88 × 10⁻¹² | | white | influence | | | | | | |
| | | | | crystal | | | fluorescent | | | | | | | |
| | | | | | | | lamp | | | | | | | |
| Example 19 | | 80/20 | 454 nm, | Cholesteric | PC | 70 μm | Normal | No | A | A | B | A | A | |
| | | | 595 nm | liquid | 88 × 10⁻¹² | | white | influence | | | | | | |
| | | | | crystal | | | fluorescent | | | | | | | |
| | | | | | | | lamp | | | | | | | |
| Example 20 | | 80/20 | 454 nm, | Cholesteric | PC | 70 μm | Normal | No | A | A | A | A | A | |
| | | | 694 nm | liquid | 88 × 10⁻¹² | | white | influence | | | | | | |
| | | | | crystal | | | fluorescent | | | | | | | |
| | | | | | | | lamp | | | | | | | |
| Example 21 | Polymerizable | 80/20 | 454 nm | — | PC | 55 μm | Circularly | No | A | A | A | A | A | |
| | cholesteric liquid | | | | 88 × 10⁻¹² | | polarized | influence | | | | | | |
| | crystal | | | | | | light | | | | | | | |
| Example 22 | | 80/20 | 454 nm | — | PC | 55 μm | Circularly | No | A | A | A | A | A | |
| | | | | | 88 × 10⁻¹² | | polarized | influence | | | | | | |
| | | | | | | | light | | | | | | | |
| Comparative | Monodispersed | | | | | | | No | C | | | | | |
| Example 1 | particles | | | | | | | influence | | | | | | |
| Comparative | Common | | | | | | | Influence | A | | | | | |
| Example 2 | cholesteric liquid | | | | | | | | | | | | | |
| | crystal | | | | | | | | | | | | | |

### REFERENCE NUMERALS AND SYMBOLS

1 selective reflection layer
2 birefringence layer
3 support
4 circularly polarized light separating layer (cholesteric liquid crystal layer)
5 linearly polarized light separating layer
6 λ/4 phase difference layer
7 light shielding layer
8 adhesive layer

What is claimed is:

1. A stress display member comprising:
a selective reflection layer,
wherein the selective reflection layer includes one or more cholesteric liquid crystal layers that are obtained by curing a liquid crystal composition including a polymerizable liquid crystal compound, and
the selective reflection layer is a layer that selectively reflects circularly polarized light having any one sense of right-handed circularly polarized light and left-handed circularly polarized light in a selective reflection wavelength.

2. The stress display member according to claim 1,
wherein the polymerizable liquid crystal compound includes a polyfunctional liquid crystal compound having 2 or more polymerizable groups and a monofunctional liquid crystal compound having one polymerizable group, and
wherein a mass ratio of the polyfunctional liquid crystal compound and the monofunctional liquid crystal compound is 30/70 to 99/1.

3. The stress display member according to claim 1, further comprising:
a birefringence layer,
wherein the birefringence layer is a layer in which birefringence changes if a stress is applied.

4. The stress display member according to claim 3,
wherein an absolute value of a photoelastic coefficient of the birefringence layer which is indicated by a unit of Pa⁻¹ is 20×10⁻¹² to 1×10⁻⁶.

5. The stress display member according to claim 3, further comprising:
a circularly polarized light separating layer,
wherein the circularly polarized light separating layer is a layer that selectively transmits circularly polarized light in a wavelength region including the selective reflection wavelength.

6. The stress display member according to claim 5,
a sense of the circularly polarized light transmitted by the circularly polarized light separating layer is the same as a sense of the circularly polarized light selectively reflected by the selective reflection layer.

7. The stress display member according to claim 5,
wherein the sense of the circularly polarized light transmitted by the circularly polarized light separating layer is the reverse of the sense of the circularly polarized light selectively reflected by the selective reflection layer.

8. The stress display member according to claim 5, further comprising:
the selective reflection layer, the birefringence layer, and the circularly polarized light separating layer, in this sequence.

9. The stress display member according to claim 5,
wherein the circularly polarized light separating layer is a layer made with a laminated body including a linearly polarized light separating layer and a λ/4 phase difference layer.

10. The stress display member according to claim 9,
wherein an absolute value of the photoelastic coefficient of the λ/4 phase difference layer which is indicated by a unit of Pa⁻¹ is 20×10⁻¹² to 1×10⁻⁶.

11. The stress display member according to claim 5,
wherein the circularly polarized light separating layer includes a cholesteric liquid crystal layer obtained by curing a liquid crystal composition including a polymerizable liquid crystal compound.

12. The stress display member according to claim 11,
wherein a spiral pitch of one or more cholesteric liquid crystal layers included in the selective reflection layer is identical to a spiral pitch of one or more cholesteric liquid crystal layers included in the circularly polarized light separating layer.

13. The stress display member according to claim 3,
wherein the selective reflection layer includes 2 or more cholesteric liquid crystal layers obtained by curing a liquid crystal composition including a polymerizable liquid crystal compound, and
wherein spiral pitches of the 2 or more cholesteric liquid crystal layers are different from each other.

14. The stress display member according to claim 13,
wherein a difference between peak wavelengths of the 2 or more cholesteric liquid crystal layers that selectively reflect circularly polarized light is 50 nm or greater.

15. The stress display member according to claim 1, which is a film having a film thickness of 1,000 μm or less.

16. The stress display member according to claim 1, further comprising an adhesive layer in an outermost layer.

17. The stress display member according to claim 1, further comprising a light shielding layer.

18. A strain measurement method of a target, comprising:
adhering the stress display member according to claim 1 to the target; and
measuring reflected light or transmitted light obtained by irradiating the stress display member with light in a wavelength region including a selective reflection wavelength.

19. A strain measurement method of a target comprising:
adhering the stress display member according to claim 3 to the target; and
measuring reflected light obtained by irradiating the stress display member with circularly polarized light in a wavelength region including the selective reflection wavelength.

20. A strain measurement method of a target, comprising:
adhering the stress display member according to claim 1 to the target; and
measuring reflected light or transmitted light obtained by irradiating the stress display member with light,
wherein a peak wavelength of the irradiated light is in a wavelength region in which the selective reflection layer selectively reflects light, and
wherein the wavelength region of the irradiated light is smaller than a wavelength region in which the selective reflection layer selectively reflects light.
